(19) United States
(12) Patent Application Publication
(10) Pub. No.: US 2011/0260370 A1
(43) Pub. Date: Oct. 27, 2011

(54) METHOD AND DEVICE FOR INFRARED HEATING OF PLASTIC PREFORMS

(76) Inventor: Gregoire Lize, Lyon (FR)

(21) Appl. No.: 13/130,618

(22) PCT Filed: Nov. 23, 2009
(86) PCT No.: PCT/FR2009/052257

§ 371 Date: Jun. 24, 2011

(30) Foreign Application Priority Data
Nov. 24, 2008 (FR) 08/06585

(51) Int. Cl. B29C 49/64

(52) U.S. Cl. 264/481; 425/174.4

(57) ABSTRACT

The invention relates to a device and to a method for producing containers (2) such as bottles or drums, using preforms (3) preferably made of plastic, including the steps of supplying preforms (3), pre-heating the performs (3) by radiation in a heating module (5), and stretching and/or blowing the performs (3) by a blower (7), characterised in that the radiation has a wavelength between 1.5 μm and 2 μm and a device (1) for the production of containers (2) such as bottles or drums, using performs (3) preferably made of plastic, including a preform (3) conveyor (4), a heating module (5) including infrared emitters (6) and a bottle blower (7). The radiation has an emission peak corresponding to a wavelength between 1.7 μm and 5 μm, and the metal filament has an emission surface such that the ratio of the emitter input power to the filament emission surface is between 0.080 and 0.250 W/mm².

### TECHNICAL FIELD

The present invention relates to the field of plastic materials and their transformation to produce wrapping or packaging products. The invention in particular relates to a method and a device for producing containers from plastic preforms such as bottles or drums.

### BACKGROUND

Plastic materials such as polyesters, and in particular polyethylene terephthalate (PET) and its copolymers, are well known for the production of all kinds of wrapping or packaging materials, such as bottles, drums, boxes, films, bags, etc.

In the industry, the majority of container production is done by specialized machines called PET bottle blowers, from a preform that is then blown to be turned into a bottle. Some of these machines can produce up to 50,000 containers per hour for the smallest containers. This chain production is done in several steps.

The first step consists of supplying the machines with preforms. The preforms go from a supply hopper to a loading conveyor that allows them to be inserted into the production chain while giving them a predefined orientation. The preforms are then directed towards a heating module located at the inlet of the bottle blower.

The second step consists of heating the preforms. The preforms are heated continuously throughout their passage in the heating module. This heating is done by infrared emitters.

This equipment allows rapid increases in temperature and is commonly used in various industrial sectors, in particular to heat metal body pieces while going through paper drying or industrial glues.

During the heating step, the preforms rotate constantly, so as to ensure optimal and symmetrical distribution of the heat.

Furthermore, during this heating step, it is necessary under the aforementioned conditions to perform a substantial injection of air inside the heating module in order to stabilize the surface temperatures of the preforms and prevent overheating of the skin.

The third step consists of stretching and blowing the preforms. This step comprises two phases: stretching and pre-stretching, which take place simultaneously, by lowering a stretching bar, introducing low-pressure compressed air, and the final blowing via high-pressure compressed air, owing to which the bottles assume their final shape.

The last step consists of taking out the bottles. The finished bottles are withdrawn from stretching-blowing stations using a group of clamps, then are taken out to be directed towards the filling machines.

The major drawback of this production method lies in the high energy consumption it creates for its implementation. This high consumption can be imputed on one hand to the operation of the infrared emitters and on the other hand to having to cool the surface of the preforms to prevent the skin from overheating.

To date it was explained by the manufacturers of blowers as well as the manufacturers of halogen electric infrared emitters that the best way to quickly increase the temperature of the preforms was to use so-called short infrareds typically between 1 and 2 μm in wavelength and whereof the emission peak is between 1 and 1.3 μm.

Thus, documents FR2878185, WO95/11791 describe methods of this type in which the wavelength of the radiation used is between 0.7 and 1.6 μm.

Other types of infrared emission devices have been considered. Thus, document U.S. Pat. No. 4,385,089 describes the use of a preheating furnace with radiant panels with an emission maximum at 2 μm.

It is also known from document US2007/0096352 to use laser diode assemblies having an emitting wavelength in the vicinity of 2 μm.

This type of laser diode cannot, however, be used simply because the beams have a small angular gap and require that scanning of the preforms be done.

Lastly, document GB2095611 describes a method in which the heating of the preforms is done with an alternation of high-power heating and low-power heating phases, quartz lamps being powered with different powers during these two phases so as to produce radiation with a wavelength in the vicinity of 1.15 μm during a first phase, and 2.9 μm during a second phase.

The power phases producing an emission peak at 2.9 μm correspond to phases in which the emitted radiant energy is insignificant, according to the terms of this document. These phases make it possible to keep the lamps on and prevent a complete stop between two high-power phases.

### BRIEF SUMMARY

The present invention aims to resolve all or some of the drawbacks of the prior art.

To that end, the present invention relates to a method for producing containers such as bottles or drums, using preforms preferably made of plastic, including the steps of supplying preforms, pre-heating the preforms by radiation in a heating module, the radiation being generated by at least one emitter comprising a metal filament housed in an enclosure filled with a halogen gas, and stretching and/or blowing the preforms by a blower, characterized in that the radiation has an emission peak corresponding to a wavelength between 1.7 μm and 5 μm, and in that the metal filament has an emission surface such that the ratio of the emitter input power to the filament emission surface is between 0.080 and 0.250 W/mm².

The provisions according to the present invention make it possible to use a wavelength with an emission peak higher than that used in the prior art with halogen emitters while keeping an emitted power density sufficient to obtain effective heating of the preforms.

The use of the wavelengths according to the invention causes heating on the surface of the preforms by radiation, contrary to the shorter wavelengths that penetrate a superficial layer of the material with a thickness in the vicinity of 10 to 15 μm.

In the event short wavelengths are used according to the prior art, given the heated polymer thickness, crystallization can occur when the temperature exceeds a threshold temperature.

Owing to the surface heating in the wavelength range according to the invention, such a crystallization is not caused, even when the surface temperature increases beyond a crystallization threshold.

The heating inside the preform is obtained by conduction.

The use of halogen electric infrared emitters emitting an infrared radiation with a wavelength greater than what has been used to date, i.e. a radiation with a wavelength at 1.2 μm., alone causes about 35 to 50% growth of the yield relative to a standard use at 1.2 μm.

Advantageously, the ratio between the input power of the transmitter and the emission surface of the filament is between 0.150 and 0.200 and preferably between 0.160 and 0.175 W/mm².

According to one embodiment, the radiation has an emission peak corresponding to a wavelength between 2 μm and 4 μm.

Advantageously, the preforms are subjected to an environment without blowing of a coolant flow or in an environment where the blowing or injection of coolant presents a flow rate related to the input power of the emitter below 30 m³/kW/h during the preheating phase.

It should be noted that the provisions according to the invention that avoid causing crystallization, even at a high temperature, also make it possible to limit or eliminate cooling of the preforms by blowing air.

It is no longer necessary to blow large quantities of air into the heating module to prevent overheating of the surfaces of the preforms.

Indeed, it was even shown during the implementation of the invention that, contrary to expectations, the air was reducing the global yield, because it was dissipating the energy concentrated at the surface of the preform.

According to one embodiment, the air is injected during the preheating step so as to create a flow of coolant oriented towards at least part of an emitter.

The present invention also relates to a device for producing containers such as bottles or drums, from preforms preferably made of plastic, including a preform conveyor, a heating module including at least one infrared emitter comprising a metal filament housed in an enclosure filled with a halogen gas, and a bottle blower, characterized in that the at least one infrared emitter produces a radiation having an emission peak corresponding to a wavelength between 1.7 μm and 5 μm, and in that the metal filament has an emission surface such that the ratio between an input power of the emitter and the emission surface of the filament is between 0.100 and 0.250 W/mm².

Advantageously, the ratio between the input power of the emitter and the emission surface of the filament is between 0.150 and 0.200, and preferably between 0.160 and 0.175 W/mm².

According to one embodiment, the at least one infrared emitter produces a radiation having an emission peak corresponding to a wavelength between 2 μm and 4 μm.

Advantageously, the filament has a profile comprising polygonal portions or polygonal portions with rounded points.

According to one embodiment, the filament has a profile having portions whereof the projection on a plane forms a star polygon, preferably comprising rounded tips.

Advantageously, a flow of coolant created by a blowing machine is only oriented towards the infrared emitters.

According to one embodiment, at least one wall, preferably made of quartz, is inserted between the infrared emitters and the preforms so as to isolate the preforms from the flow of coolant.

This arrangement makes it possible to isolate the preforms from the air circulating around the emitters.

According to the same embodiment, the heating module comprises infrared reflectors adapted to the wavelength of the emitter. Advantageously, the infrared reflectors are arranged on either side of the at least one emitter, for example such that the preforms can be supplied between the at least one transmitter and one of the infrared reflectors.

A proper implementation of the environment through the use of infrared reflectors adapted to the wavelength of the radiation and management of the air on the emitters and the atmosphere of the furnace makes it possible to further improve the yield by 15 to 20% relative to the prior art. The reflectors used can for example approach the ideal characteristics of a black body.

### BRIEF DESCRIPTION OF THE DRAWINGS

The invention will be well understood with the help of the following description, in reference to the appended drawings, showing, as non-limiting examples, part of the device for producing containers according to the invention.

FIG. 1 shows a synoptic view of the device for producing containers according to the invention.

FIG. 2 shows a diagrammatic top view of the heating module of the device according to a first embodiment of the invention.

FIG. 3 shows a diagrammatic profile view of this same heating module of the device according to the first embodiment of the invention.

FIG. 4 shows a diagrammatic profile view of the heating module of the device according to a second embodiment of the invention.

FIG. 5 shows a distribution of the energy emitted along the wavelength corresponding to the energy peak emitted by an infrared source of the quartz lamp type.

FIG. 6 shows the temperature rise caused on the skin of the preforms in a traditional system and with the method according to the invention.

FIG. 7 shows a transverse cross-section of a transmitter used in a device and method according to the invention, this cross-system only showing part of the coils of the filament.

### DETAILED DESCRIPTION

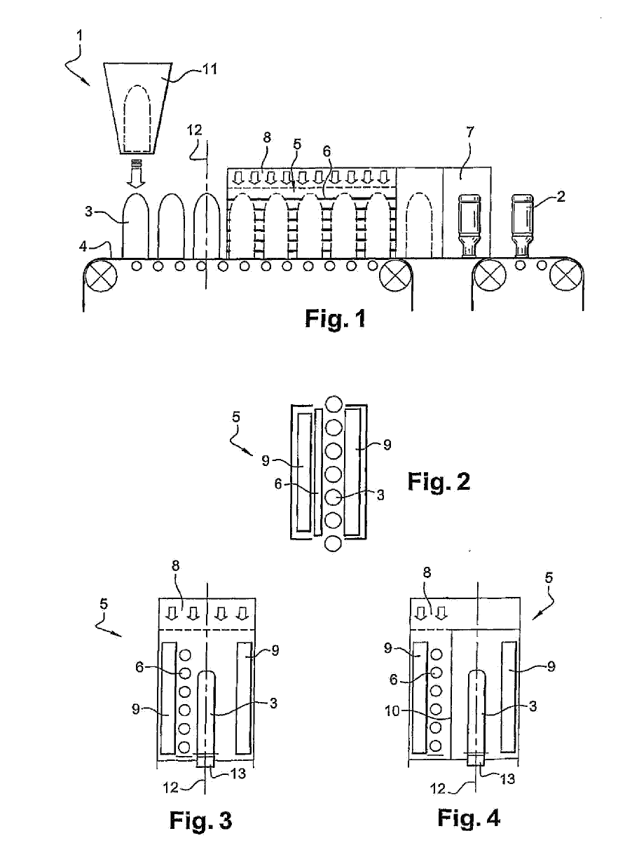

According to the invention, in reference to FIG. 1, a device 1 for producing containers 2 comprises a preform 4 conveyor 3, a heating module 5 comprising infrared emitters 6, and an air blower 8 leaning against it.

The conveyor 3 is equipped with rotation means 13 shown in FIG. 3 making it possible to continuously cause the preforms to rotate around an axis of rotation 12. In order to allow better penetration of the infrareds in the material, the speed of rotation can be reduced relative to that of a conventional device that used this speed of rotation to cool the surface of the preforms and thereby prevent the skin effect.

The infrared emitters 6 are arranged along a plane substantially parallel to the plane described by the passage of the preforms 3 during their passage in the heating module 5.

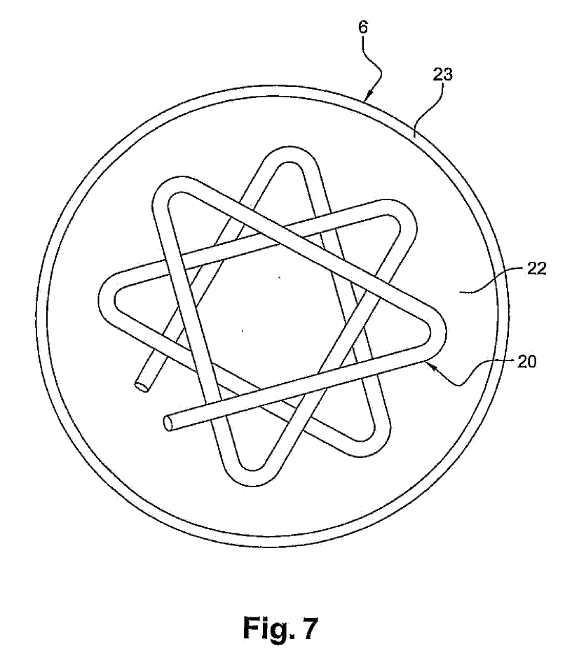

As shown in FIG. 7, the infrared emitters 6 according to the invention are halogen emitters, comprising a metal filament 20 housed in an enclosure 22 filled with a halogen gas. The filament 20 is for example made from tungsten. The enclosure wall 23 of the emitter can for example be made from quartz.

Preferably, the emitter is made with an oblong shape, the enclosure being tubular and sealed at both ends. The filament is extruded or twisted around a primary direction in the axis of the emitter.

The profile of the filament shown in cross-section projected on a plane perpendicular to the main direction of the emitter corresponds substantially to a polygonal and/or star shape with rounded tips or of the hypothrochoid type, this type of curve making it possible to form an approximation of a polygonal shape.

This shape corresponding to the development of a star polygon makes it possible to ensure a larger effective emission surface. In the example shown in FIG. 7, a star polygonal shape with 8 rounded tips is proposed. However, it is possible to consider other filament profiles with the aim of having an increased emission surface, in particular with other polygonal shapes.

Furthermore, the diameter of the filament is thick relative to a traditional emitter so as to obtain a ratio between the input power and the filament surface preferably between 0.160 and 0.175 W/mm².

The diameter of the filament is preferably between 0.4 and 0.7 mm in the various embodiments of the invention. The dimension of the cylinder covering the profile of the filament is preferably between 14 and 21 mm.

Thus, an example of an emitter from the prior art comprises a filament with an emitting surface of 4,104 mm² for a power of 2,000 W (+/−5%).

According to one embodiment of the invention, an emitter comprises a filament with an emitting surface of 12,040 mm² for a power of 2,000 W (+/−5%).

Thus the emitting surface is increased by a factor greater than or equal to 3 for a same emitting power relative to the devices of the prior art.

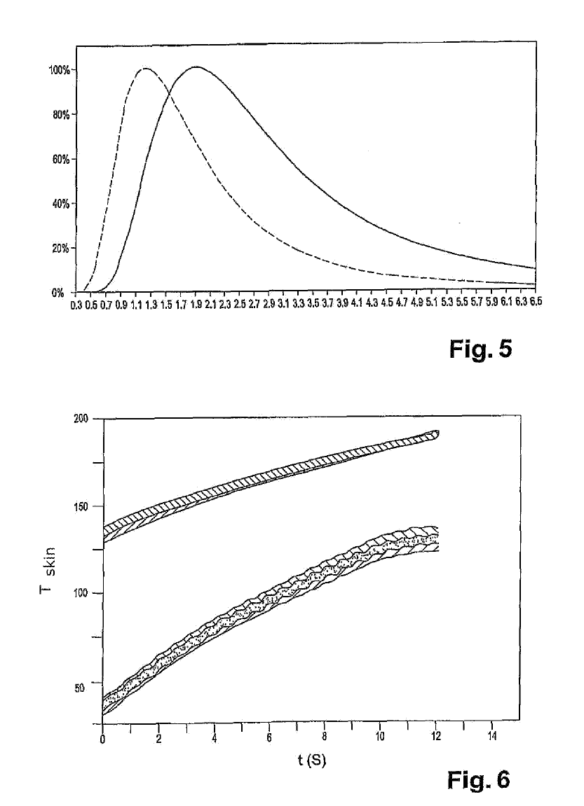

It should be noted that FIG. 5 describes the distribution of the energy in the case of two types of emitters, one emitting with an emission peak at 1.2 μm, and the other with an emission peak at 1.9 μm. It appears clearly in this diagram that the transmission energy is distributed more diffusely when the wavelength increases. The heating module 5 also comprises infrared reflectors 9 arranged along a plane substantially parallel to the plane in which the infrared emitters 6 fit and on either side of said same infrared emitters 6 so as to limit the losses of energy inside the heating module 5.

Arranged on the heating module 5 is an air blower 8 continuously injecting air inside the heating module 5. This air blower 8 can have several different configurations and characteristics as needed. It can for example be arranged on any side of the heating module 5, the aim being to provide enough air inside the heating module 5 to prevent the overheating of certain surfaces located inside the heating module 5, and in particular the remainder of the emitters. The flow of air created can also be laminar or turbulent.

Advantageously, the air blower has an air flow rate related to the input power of the emitter below 30 m³/kW/h, and is oriented so as only to blow air on the remainders and tubes of the quartz lamps. Indeed, the arrangements according to the invention limit or eliminate the need to perform cooling by blowing air on the preforms.

The blower 7 is arranged at the outlet of the heating module 5 at a relatively short distance therefrom to prevent excessively strong cooling of the preforms 3.

At the beginning of the production cycle, the preforms 3 are previously loaded into a hopper 11. Upon leaving said hopper 11, the preforms 3 are successively arranged on the conveyor 4 following a predetermined orientation, generally with the neck facing downwards. Once on the conveyor 4, the preforms 3 are maintained using mandrels and driven by a rotational movement of their axis of rotation 12 via rotation means 13 arranged on the conveyor 4, then they are oriented towards the inlet of the heating module 5.

Along their entire journey in the heating module 5, a continuous heating via infrared radiation is applied to the preforms 3. This radiation is produced by the infrared emitters 6 arranged along the heating module 5.

According to the invention, this radiation is emitted at a wavelength between 1.7 μm and 5 μm. The use of the wavelengths according to the invention causes heating of the surface of the preforms by radiation, contrary to the shorter wavelengths that penetrate a superficial layer of the material with a thickness in the vicinity of 10 μm.

In the case of the use of wavelengths shorter than 1.7 given the thickness of polymer directly heated, crystallization may occur when the temperature exceeds a threshold temperature.

Owing to the surface heating in the wavelength range according to the invention, such crystallization is not caused, even when the surface temperature increases beyond a crystallization threshold.

The heating inside the preform is obtained by conduction.

FIG. 6 shows the temperature profiles in a device according to the invention (on top), and the temperature profile in a heating device according to the state of the art on bottom.

It appears in these curves that in a device according to the prior art, measures are taken to prevent the temperature from exceeding the crystallization temperature of the polymer (which is in the vicinity of 150° C.).

In a device according to the invention, this surface temperature of the preforms (Tpeau) can exceed 150° C., without harmful consequences for the preforms.

The energy resulting from the infrared radiation is converted into heat and spreads by conduction from inside the material. The heating is improved by furnace effect using the walls 9.

A thermal gradient is created inside the PET material and its surface, which will reduce the need to inject large quantities of air into the heating module.

At the outlet of the preheating module 5, the preforms 3 heated to a temperature typically of 120° C. enter the blower 7. The blower 7 has a mold with a predetermined shape complementary to that of the bottle 2 to be produced. The preform 3 is engaged in this mold, then blown in order to give the bottle 2 its final shape. The bottle 2 is then discharged by a second conveyor 4 arranged at the outlet of the blower.

In a second embodiment shown in FIG. 4, it is possible to attach a wall 10 having a good transmission coefficient, preferably made from quartz, to the heating module 5. This wall 10 is arranged between the infrared emitters 6 and the preforms 3. It makes it possible to condition the movements of injected air by blowing air 8 on only the infrared emitters 6. Indeed, with these infrared emitters 6 and the thermal transfer mode they involve, it is no longer necessary to cause air to move around the preforms 3, this movement of air is on the contrary unfavorable to the desired yield gain.

Lastly, the implementation of the method according to the invention does not require significant changes or adaptations on the existing devices. It is only necessary to place the emitters differently. Indeed, with the method and its implementing device according to the invention, it is possible to carpet the surface occupied by the emitters 6 in a less dense manner than with the emitters emitting in the short infrared and on less total surface area. It is also sufficient to place very high-performing infrared reflectors 9 and to reduce the quantities of air introduced into the heating module 5 to the minimum necessary for the operation of the infrared emitters 6.

Thus, owing to the implementation of a method and its device 1 according to the invention, the yield of the industry of containers 2 and other plastic packaging increases by 40 to 60% particularly owing to the decrease in electrical consumption necessary to power the infrared emitters 6 and blowing air 8 as well as time savings during the heating phase of the preforms 3. With this method, the processing times are reduced by 20 to 50%, which considerably increases the productivity of the containers, but especially considerably reduces the electrical consumption by 40 to 60%.

Of course the invention is not limited solely to the embodiments of this device 1, or to its application according to its method, described above as an example, but on the contrary encompasses all alternatives.

1. A method for producing containers such as bottles or drums, using preforms preferably made of plastic, of the method comprising:
supplying preforms,
pre-heating the preforms by radiation in a heating module, the radiation being generated by at least one emitter comprising a metal filament housed in an enclosure filled with a halogen gas, and
stretching and/or blowing the preforms by a blower,
wherein the radiation has an emission peak corresponding to a wavelength between 1.7 μm and 5 μm, and the metal filament has an emission surface such that a ratio of an emitter input power to a filament emission surface is between 0.080 and 0.250 W/mm².

2. The method according to claim 1, wherein the ratio between the input power of the transmitter and the emission surface of the filament is between 0.150 and 0.200.

3. The method according to claim 1, wherein the radiation has a wavelength between 2 μm and 4 μm.

4. The method according to claim 1, wherein the preforms are subjected to an environment without blowing of a coolant flow or in an environment where blowing or injection of coolant presents a flow rate related to the input power of the emitter below 30 m³/kW/h during the preheating phase.

5. The method according to claim 4, wherein a coolant is blown in during the preheating step so as to create a stream of coolant oriented towards at least part of an emitter.

6. A device for producing containers such as bottles or drums, from preforms preferably made of plastic, the device comprising:
a preform conveyor,
a heating module including at least one infrared emitter comprising a metal filament housed in an enclosure filled with a halogen gas,
a bottle blower,
wherein the at least one infrared emitter produces a radiation having an emission peak corresponding to a wavelength between 1.7 μm and 5 μm, and wherein the metal filament has an emission surface such that a ratio between an input power of the emitter and an emission surface of the filament is between 0.80 and 0.250 W/mm².

7. The device according to claim 6, wherein the ratio between the input power of the emitter and the emission surface of the filament is between 0.150 and 0.200.

8. The device according to one of claim 6, wherein the at least one infrared emitter produces a radiation having an emission peak corresponding to a wavelength between 2 μm and 4 μm.

9. The device according to claim 6, wherein the filament has a profile comprising polygonal portions or polygonal portions with rounded points.

10. The device according to claim 10, wherein the filament has a profile having portions whereof the projection on a plane forms a star polygon comprising rounded tips.

11. The device according to claim 6, wherein a flow of coolant created by a blowing machine is only oriented towards the infrared emitters.

12. The device according to claim 11, wherein at least one wall, made of quartz, is inserted between the infrared emitters and the preforms so as to isolate the preforms from the flow of coolant.

13. The device according to claim 6, wherein the heating module comprises infrared reflectors adapted to the wavelength of the emitter.
